(19) United States
(12) Patent Application Publication
(10) Pub. No.: US 2023/0004169 A1
(43) Pub. Date: Jan. 5, 2023

(54) Apparatus and Method for Controlling Mobile Body

(71) Applicant: Hitachi Astemo, Ltd., Hitachinaka-shi, Ibaraki (JP)

(72) Inventors: Hideaki KIDO, Tokyo (JP); Tatsuhiko MONJI, Hitachinaka (JP); Shigenori HAYASE, Tokyo (JP)

(21) Appl. No.: 17/779,847

(22) PCT Filed: Nov. 4, 2020
(86) PCT No.: PCT/JP2020/041140

§ 371 Date: May 25, 2022

(30) Foreign Application Priority Data
Nov. 26, 2019 (JP) 2019-213480

(51) Int. Cl. G05D 1/02; G01S 13/931; G01S 13/86

(52) U.S. Cl. CPC G05D 1/0251; G05D 1/0274; G01S 13/931; G01S 13/867; G01S 2013/93271; G05D 2201/0213

(57) ABSTRACT

An apparatus and the like for controlling a mobile body that are capable of adjusting a detection result by a radar device in accordance with a three-dimensional shape for each region of a three-dimensional map generated from an image captured by an image-capturing device are provided. A mobile body control unit 105 is an apparatus for controlling the vehicle (mobile body) including an image-capturing device 101 and a millimeter wave radar device 102 (radar device). A three-dimensional map generation unit 203 generates a three-dimensional map around the vehicle from an image captured by the image-capturing device 101. A radar weight map estimation unit 204 (weight estimation unit) estimates the weight of the detection result by the millimeter wave radar device 102 for each region of the three-dimensional map from the three-dimensional shape for each region of the three-dimensional map. A weight adjustment unit 205 (adjustment unit) adjusts a detection result by the millimeter wave radar device 102 on the basis of a weight.

### TECHNICAL FIELD

The present invention relates to an apparatus and a method for controlling a mobile body.

### BACKGROUND ART

In achievement of automatic driving and an advanced safety driving support system, importance of a sensor that monitors the outside world and detects an object necessary for own vehicle travel such as an obstacle and lane information is increasing. Outside world monitoring sensors come in types such as a camera, a millimeter wave radar, and LIDAR, each of which has characteristics of a sensor, and there are advantages and disadvantages in a traveling scene.

For example, a camera becomes difficult to detect in a case of backlight. When there is a large reflective object beside a detection target object, a millimeter wave radar has a multipath, in which a radar wave is reflected once on the reflective object, is reflected again on another object, and returns, occurs, thereby becoming likely to cause erroneous measurement of a distance and an arrival angle and erroneous detection due to clutter.

In order to solve this problem, for example, PTL 1 discloses a technology of determining, using map information for navigation, the presence or absence of a sidewall that causes erroneous detection when detecting an object by a millimeter wave radar, and reducing or stopping the monitoring frequency of the millimeter wave radar, thereby suppressing output of sensor information in a state of low reliability. For example, PTL 2 proposes a technology of performing object detection with a millimeter wave radar by combining map information created by a stereo camera and detection of a polarization region, thereby suppressing a reflected wave from a metal object on a road surface.

### CITATION LIST

### Patent Literature

PTL 1: JP 2900737 A
PTL 2: WO 2017/057058

### SUMMARY OF INVENTION

### Technical Problem

PTL 1 makes it possible to predict an object registered in a navigation map, but not possible to cope with a case where an object not registered in the navigation map induces a detection error of a millimeter wave radar. For example, it cannot solve a case where a large trailer is traveling beside a detection target object or there is a guardrail not registered on the map.

PTL 2 discloses a method for detecting a metal object on a road surface, but does not describe a response to a situation where a multipath can occur.

An objective of the present invention is to provide an apparatus and a method for controlling a mobile body that are capable of adjusting a detection result by a radar device in accordance with a three-dimensional shape for each region of a three-dimensional map generated from an image captured by an image-capturing device.

### Solution to Problem

In order to achieve the above objective, an example of the present invention is an apparatus for controlling a mobile body that has an image-capturing device and a radar device, the apparatus including: a three-dimensional map generation unit that generates a three-dimensional map around the mobile body from an image captured by the image-capturing device; a weight estimation unit that estimates, from a three-dimensional shape of each region of the three-dimensional map, a weight of a detection result by the radar device for each region of the three-dimensional map; and an adjustment unit that adjusts a detection result by the radar device based on the weight.

### Advantageous Effects of Invention

According to the present invention, it is possible to adjust a detection result by the radar device in accordance with the three-dimensional shape of each region of a three-dimensional map generated from an image captured by the image-capturing device. Problems, configurations, and effects other than those described above will be made clear by the description of the following embodiment.

### BRIEF DESCRIPTION OF DRAWINGS

FIG. 1 is a view explaining a configuration of an in-vehicle mobile body control apparatus according to a first embodiment.

FIG. 2 is a view explaining a configuration of a mobile body control unit illustrated in FIG. 1.

FIG. 3 is a view explaining a configuration of a three-dimensional map generation unit illustrated in FIG. 2.

FIG. 4 is a view explaining a configuration of a radar weight map estimation unit.

FIG. 5 is a view explaining an example of a specific shape registered in a specific shape database.

FIG. 6A is a view illustrating a behavior of the radar weight map estimation unit in a state where a plurality of vehicles are in front.

FIG. 6B is an overhead view of a three-dimensional map.

FIG. 6C is a view for explaining an operation of the radar weight map estimation unit.

FIG. 7 is a view utilizing past map information.

FIG. 8 is a view utilizing past composite map information.

FIG. 9 is a flowchart showing processing executed by the mobile body control apparatus.

### DESCRIPTION OF EMBODIMENTS

An embodiment of the invention will be described below. The present embodiment relates to a system that highly understands a surrounding environment in automatic driving and an advanced safety driving system.

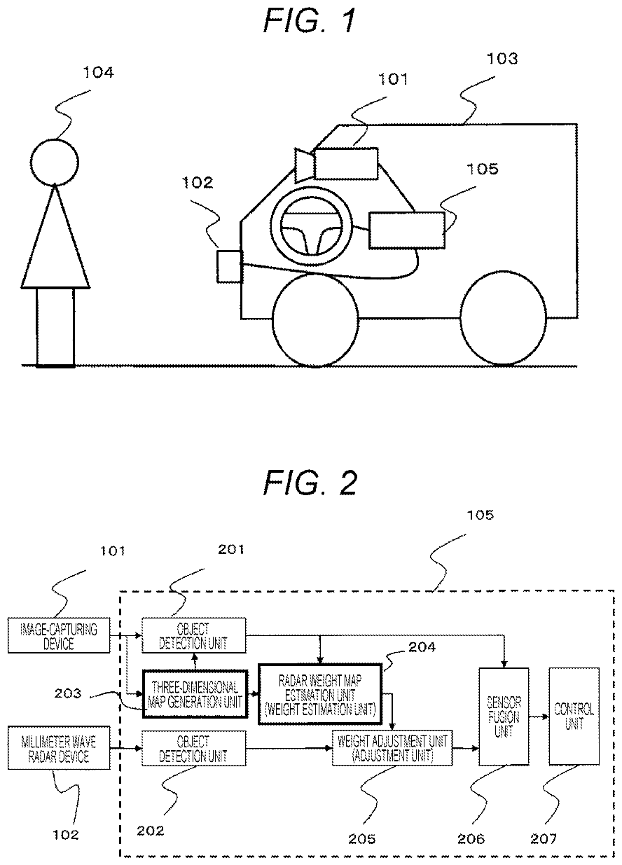

FIG. 1 illustrates a vehicle control system using an image-capturing device and a millimeter wave radar.

An image-capturing device 101 and a millimeter wave radar device 102 are mounted on a vehicle 103, and measure and transmit, to a mobile body control unit 105, a distance to an object 104 in front and a relative speed, for example. The mobile body control unit 105 determines control of the brake and the accelerator from the distance to the object 104 and the relative speed, and controls the vehicle 103.

That is, the mobile body control unit 105 is an apparatus for controlling the vehicle 103 (mobile body) including the image-capturing device 101 and the millimeter wave radar device 102 (radar device).

FIG. 2 illustrates a first mode of the mobile body control unit 105 that implements the present invention. Note that the mobile body control unit 105 is, for example, an electronic control unit (ECU), and includes a memory (storage device), a CPU (processor), and an input/output circuit (communication device).

Object detection units 201 and 202 are provided in the mobile body control unit 105 for the image-capturing device 101 and the millimeter wave radar device 102, respectively, and detect various objects that exist in the field of view seen from the own vehicle (vehicle 103). The image-capturing device 101 causes a three-dimensional map generation unit 203 to generate a three-dimensional map in real time from acquired sensor information. Here, the three-dimensional map has information (e.g., distance information) in a depth direction, a height direction, and a lateral direction of an object existing in the field of view of a sensor.

As the three-dimensional map, a distance image by a stereo camera may be used, a sensor that acquires a point group having distance information as LIDAR may be used, or generation of distance information by time series analysis using a monocular camera or generation of a distance image by learning may be used, and the means does not matter.

After the three-dimensional map is generated, radar weight map estimation is performed. A radar weight map estimation unit 204 generates a weight value indicating how reliable a radar signal arriving from each point on the three-dimensional map is at the point. Using a result of the radar weight map estimation unit 204, a weight adjustment unit 205 performs adjustment of values related to detection, such as the reliability, existence probability, and distance accuracy of an object detected by the object detection unit 202 on the millimeter wave radar device 102 (radar device) side. The result is input to a sensor fusion unit 206.

The sensor fusion unit 206 matches with a result of the object detection unit 201 on the image-capturing device side to make one signal, and transmits the signal to a control unit 109. That is, the sensor fusion unit 206 synthesizes a detection result by the image-capturing device 101 and a detection result by the millimeter wave radar device 102 (radar device) adjusted based on the weight, and outputs a detection result that is synthesized. This makes it possible to secure the reliability of the composite detection result. The control unit 109 generates a signal for controlling the vehicle in accordance with the result.

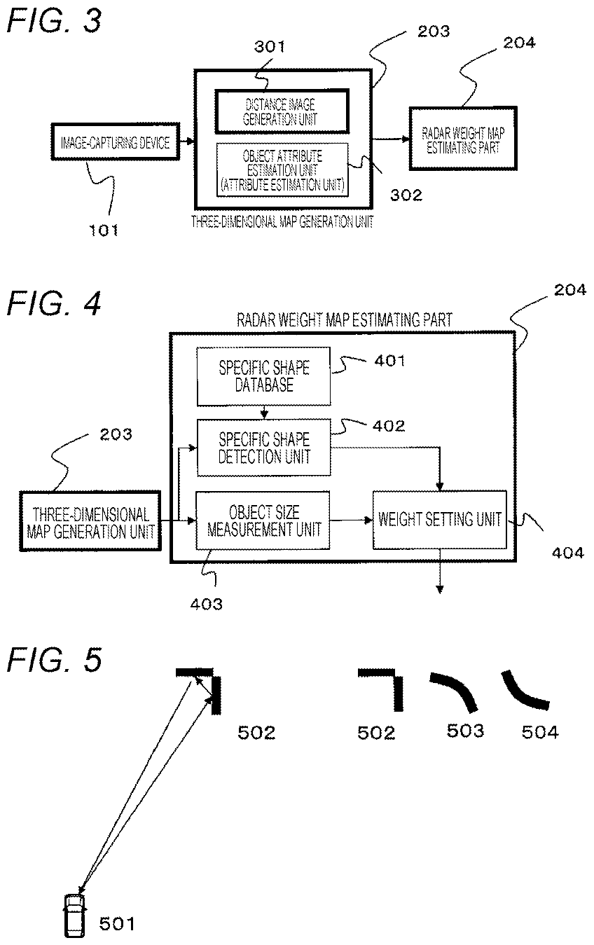

FIG. 3 illustrates a configuration example of the three-dimensional map generation unit 203.

Here, an example of a case of use of a stereo camera as an example of the image-capturing device 101 will be described. The stereo camera can measure a distance on the basis of the principle of triangulation from parallaxes of two or more cameras that are installed, and can output the distance as a distance image generation unit 301 and handle it as a three-dimensional map having distance information in the horizontal direction and the vertical direction. The three-dimensional map generation unit 203 includes at least such a function.

In other words, the three-dimensional map generation unit 203 generates a three-dimensional map around the vehicle 103 (mobile body) from an image captured by the image-capturing device 101. Note that the result of the three-dimensional map generation unit 203 created here can also be used for the object detection unit 201 of the image-capturing device 101.

In addition, the three-dimensional map generation unit 203 includes an object attribute estimation unit 302 that estimates the attribute and the material of the object for each distance by image analysis after image capturing. As a generally known method for estimating the attribute of an object, use of a discriminator, semantic segmentation, instance segmentation, and the like for an image are known as well-known technologies, and the method does not matter here.

In other words, the three-dimensional map generation unit 203 includes the object attribute estimation unit 302 (attribute estimation unit) that estimates the attribute of the object detected from an image captured by the image-capturing device 101. The attribute of an object to be estimated is, for example, a pedestrian, a vehicle, a wall, a tree, a curbstone, a guardrail, or a pole.

Note that the radar weight map estimation unit 204 (weight estimation unit) may estimate (set) the weight of the detection result by the millimeter wave radar device 102 (radar device) for each region of the three-dimensional map from a combination of the three-dimensional shape (e.g., corner shape) for each region of the three-dimensional map and the attribute (e.g., guardrail) of the object. For example, a small weight is associated with a combination of a “corner shape” as a three-dimensional shape and a “guardrail” as an attribute of an object, and stored in the memory.

This makes it possible to adjust the detection result by the radar device in accordance with the combination of the three-dimensional shape (e.g., corner shape) for each region of the three-dimensional map generated from the image captured by the image-capturing device and the attribute (e.g., guardrail) of the object estimated by the attribute estimation unit.

FIG. 4 illustrates a configuration example of the radar weight map estimation unit 204.

In the radar weight map estimation unit 204, information created by the three-dimensional map generation unit 203 is input. By detecting a specific shape with reference to a registered specific shape database 401, a specific shape detection unit 402 estimates a place where a multipath possibly occurs, and causes a weight setting unit 404 to assign a low weight to the detected place.

In other words, the radar weight map estimation unit 204 (weight estimation unit) estimates the weight of the detection result by the millimeter wave radar device 102 (radar device) for each region of the three-dimensional map from the three-dimensional shape for each region of the three-dimensional map.

The specific shape database 401 retains a feature of a shape that is likely to cause a multipath. In the specific shape database 401, there is a case where it is necessary to change the weight setting depending on the material of the shape as described later, and it is therefore conceivable to also transmit the material information of the shape to the weight setting unit.

As a different implementation method, an object size measurement unit 403 detects a large object that is likely to cause a multipath, and the weight setting unit 404 assigns low reliability to the surroundings of it.

In other words, in a case where there is an object (first object) having a predetermined size or larger in the three-dimensional map, the radar weight map estimation unit 204 (weight estimation unit) lowers the weight of the detection result by the millimeter wave radar device 102 (radar device) for each region of the three-dimensional map around the object (first object). This makes it possible to lower the reliability of the detection result by the radar device around a large trailer, for example, in a case where the large trailer that is likely to induce a multipath exists around the mobile body (own vehicle).

In a case where there is another object (second object) close to the object (first object) in the three-dimensional map, the radar weight map estimation unit 204 (weight estimation unit) may lower the weight of the detection result by the millimeter wave radar device 102 (radar device) for each region of the three-dimensional map around the object (first object) and the other object (second object). This makes it possible to lower the reliability of the detection result by the radar device around a trailer and a passenger car traveling side by side, for example, in a case where the large trailer and the passenger car travel side by side.

FIG. 5 illustrates an example of the specific shapes registered in the specific shape database 401.

This specific shape varies depending on the arrival angle from the sensor, but a shape in the direction illustrated at 501 is illustrated here. This figure illustrates a specific shape in a bird eye view. A multipath is likely to occur at a corner (concave) part as indicated by 502. There is an example in which the shape continuously changes or a possibility that a similar phenomenon occurs in a shape 503. Reversely, in a shape 504 in which a circular (convex) pattern is oriented in a vehicle direction, a strong reflection is incident on the vehicle, and thus a signal from there becomes dominant, which affects a signal group from another, and there is a possibility of erroneous measurement.

As described above, this specific shape varies depending on the arrival angle of the sensor. As a storage method into the specific shape database 401, it is conceivable to store the specific shape in a point sequence, and adjust and output, from the specific shape database 401, the shape using the absolute value of the arrival angle and the reference distance as parameters.

In the present embodiment, when the three-dimensional shape is a corner shape or a circle shape, the radar weight map estimation unit 204 (weight estimation unit) lowers the weight of the detection result by the millimeter wave radar device 102 (radar device) in a region of the three-dimensional map corresponding to the three-dimensional shape. As a result, in the case where the three-dimensional shape is a corner shape or a circular shape and is a shape that is likely to induce erroneous detection by the radar device, it is possible to lower the weight of the detection result by the radar device.

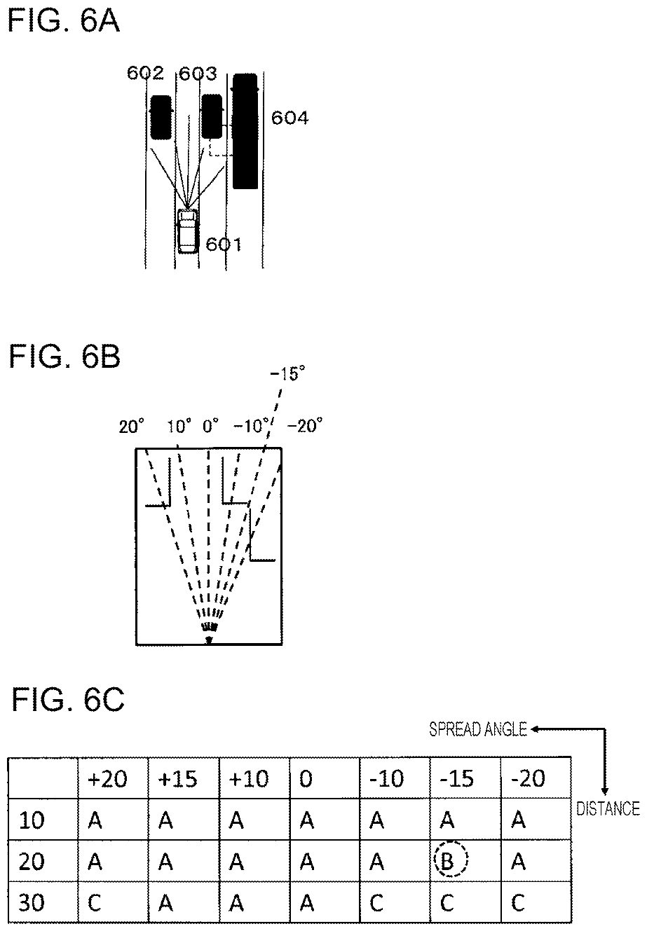

An example of the weight setting unit 404 will be explained with reference to FIGS. 6A to 6C.

Consider a case where there is an own vehicle 601 as in FIG. 6A, there are two preceding vehicles 602 and 603 in front, and there is one large trailer 604. It is assumed that an overhead view of the three-dimensional map obtained from the image-capturing device 101 is obtained as in FIG. 6B. The broken line drawn in FIG. 6B indicates the reference of the spread angle from the sensor center, and indicates 20°, 10°, 0°, −10°, and −20° from the left.

By analyzing FIG. 6B, the weight setting unit 404 lowers the weight of the region, if there is a specific shape. An example of it is illustrated in FIG. 6C. The horizontal axis represents the spread angle from the sensor center, and the vertical axis represents the distance. Now, in a case where a specific shape is given from the specific shape database 401 (dictionary), on an assumption that a place corresponding to the specific shape (special shape) is at a distance of −15° and 20 m ahead, the millimeter wave radar reliability of the region is lowered compared to the others.

In this table (FIG. 6C), the reliability is higher in the order of A, B, and C (A>B>C). C is set at +20° and 30 m ahead because this is a blocked region where an object (preceding vehicle 602) is present on the near side. Since FIG. 6C is based on an overhead representation, it is represented two-dimensionally, but can actually have three-dimensional information. In that case, the weight can be changed in accordance with the height.

With such a weight map, the importance level of the detection result of the millimeter wave radar is controlled by the weight adjustment unit 205 in the subsequent stage.

Note that in particular, in a region where the shape is determined to be a guardrail or a metal object, the reflectance is generally high, and the range affected by the specific shape becomes large. Therefore, in a case where the object attribute estimation unit 302 estimates that the object is a metal body, it is necessary to apply larger weight adjustment by the weight setting unit 404.

Conversely, there is a possibility that the influence of reflection is low for an object having a low reflectance such as plastic or wood, and therefore, in a case where such estimation is performed by the object attribute estimation unit 302, it is necessary to perform adjustment so as not to affect with the weight setting unit 404. For example, in this case, the weight of the table given in FIG. 6C is changed to A at −15° and 20 m.

In other words, the three-dimensional map generation unit 203 includes the object attribute estimation unit 302 (attribute estimation unit) that estimates the material of the object detected from an image captured by the image-capturing device 101. The material of the object to be estimated is, for example, metal, stone, tree, or plastic. The radar weight map estimation unit 204 (weight estimation unit) estimates (sets) the weight of the detection result by the millimeter wave radar device 102 (radar device) for each region of the three-dimensional map from a combination of the three-dimensional shape for each region of the three-dimensional map and the material of the object. For example, a small weight is associated with a combination of a “corner shape” as a three-dimensional shape and a “metal” as a material of an object, and stored in the memory.

This makes it possible to adjust the detection result by the radar device in accordance with the combination of the three-dimensional shape (e.g., corner shape) for each region of the three-dimensional map generated from the image captured by the image-capturing device and the material (e.g., metal) of the object estimated by the attribute estimation unit.

The weight adjustment unit 205 adjusts the result detected by the millimeter wave radar device 102 from the weight set as described above. In a case where the existence probability and the distance/relative speed accuracy of the object are given at the time point of the object detection unit 202 of the millimeter wave radar device 102, it is conceivable to adjust the accuracy and probability. In a case where they are not given, the weight is processed by the sensor fusion unit 206, and may be simply added to the output of the object detection unit 202, and the method of handling the weight does not matter.

In the present embodiment, the weight adjustment unit 205 (adjustment unit) adjusts the detection result by the millimeter wave radar device 102 (radar device) on the basis of the weight. Specifically, for example, the smaller the weight becomes, the lower the reliability of the detection result by the millimeter wave radar device 102 (radar device) is evaluated. This makes it possible to adjust a detection result by the radar device in accordance with the three-dimensional shape of each region of a three-dimensional map generated from an image captured by the image-capturing device. Furthermore, it is also possible to cope with a case where the radar device detects an object that is not registered on the navigation map.

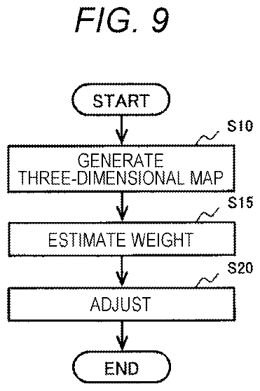

Note that, as shown in at least FIG. 9, the mobile body control unit 105 generates a three-dimensional map around the vehicle 103 (mobile body) from an image captured by the image-capturing device 101 (S10), estimates the weight of the detection result by the millimeter wave radar device 102 (radar device) for each region of the three-dimensional map from the three-dimensional shape for each region of the three-dimensional map (S15), and adjusts the detection result by the millimeter wave radar device 102 (radar device) on the basis of the weight (S20).

The sensor fusion unit 206 synthesizes and outputs, to the control unit 207, the detection results using the result detected by the millimeter wave radar device 102 and the result detected by the image-capturing device 101. As a fusion method, a method of simply adopting one with a higher weight or probability as a detection result or a method of probabilistically performing fusion as a detection result can be considered, and the method does not matter.

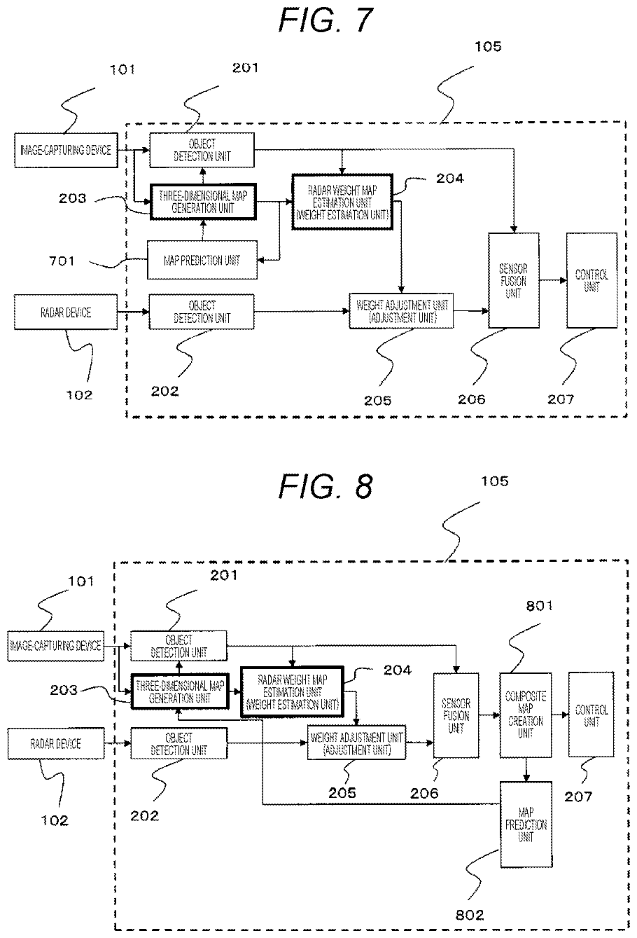

FIG. 7 illustrates an example in which past history information is input to the three-dimensional map generation unit 203.

In the mode of FIG. 7, a map prediction unit 701 appropriately predicts, from the own vehicle behavior, the speed at each position, and the like, a three-dimensional map at a next time t+1 from a three-dimensional map at a certain time t, and the three-dimensional map generation unit 203 synthesizes the map predicted at the time t when the three-dimensional map is generated next and the map at the time t+1. The composite map is used in subsequent processing. By adopting such a mechanism, extrapolation is performed from past information (three-dimensional map) even when there is an error or lack of information in the three-dimensional map acquired from the current frame, and statistical accuracy can be expected to be improved.

In other words, the mobile body control unit 105 includes the map prediction unit 701 that predicts a three-dimensional map in the next frame from a three-dimensional map. The three-dimensional map generation unit 203 generates a three-dimensional map around the vehicle 103 (mobile body) from the three-dimensional map of the next frame predicted by the map prediction unit 701 and the image captured by the image-capturing device 101. This makes it possible to improve the accuracy of the three-dimensional map generated by the three-dimensional map generation unit using the three-dimensional map before fusion.

FIG. 8 explains an example in which past history information uses map information synthesized from information of each sensor after sensor fusion.

The vehicle control system has a configuration that includes a map prediction unit 802 that predicts current map information from the fused past map information, and reflects it in the three-dimensional map generation unit 203.

In other words, the mobile body control unit 105 includes a composite map creation unit 801 that creates a three-dimensional map from the detection result synthesized by the sensor fusion unit 206, and the map prediction unit 802 that predicts a three-dimensional map in the next frame from the three-dimensional map created by the composite map creation unit 801. The three-dimensional map generation unit 203 generates a three-dimensional map around the vehicle 103 (mobile body) from the predicted three-dimensional map of the next frame and the image captured by the image-capturing device 101. This makes it possible to improve the accuracy of the three-dimensional map generated by the three-dimensional map generation unit using the three-dimensional map after fusion.

The present invention is not limited to the above-described embodiment, and includes various modifications. For example, the embodiment described above has been described in detail for an easy-to-understand explanation of the present invention, and is not necessarily limited to those having all the described configurations. It is also possible to replace part of the configuration of one embodiment with the configuration of another embodiment, and it is also possible to add the configuration of another embodiment to the configuration of one embodiment. It is further possible to add, delete, or replace other configurations for part of the configuration of each embodiment.

In the above embodiment, the image-capturing device 101 measures the distance with a stereo camera, but may measure the distance with a monocular camera. In the above embodiment, the millimeter wave radar device 102 is used as a radar device, but a radar device using a radio wave having a wavelength other than the millimeter wave may be used.

In the above embodiment, the object detection units 201 and 202 are provided in the mobile body control unit 105, but may be provided in the image-capturing device 101 and the millimeter wave radar device 102, respectively. In the above embodiment, the object detection units 201 and 202 are provided in the mobile body control unit 105, but may be provided in another ECU.

Some or all of the above-described configurations, functions, and the like may be implemented in hardware by designing them in an integrated circuit, for example. The above configurations, functions, and the like may be implemented by software by a processor interpreting and executing a program that implements each function. Information such as a program, a table, and a file that implement each function can be stored in a recording device such as a memory, a hard disk, and a solid state drive (SSD), or a recording medium such as an IC card, an SD card, and a DVD.

The embodiment of the present invention may have the following aspects.

(1). A mobile body control apparatus including an image-capturing device that detects an object in an outside world, and a millimeter wave radar device, the apparatus including: a three-dimensional map generation unit that generates a three-dimensional map around a mobile body from information of the image-capturing device; a radar weight estimation unit that estimates, from a three-dimensional shape, a weight of a detection result by the millimeter wave radar device for each region based on a distance and an azimuth using the three-dimensional map; and a weight adjustment unit that adjusts reliability of the object detected by the radar device based on a weight estimated by the radar weight estimation unit.

(2). A mobile body control apparatus, in which, based on the three-dimensional map according to (1), a radar reliability estimation unit according to (1) lowers a reliability of the radar device for each azimuth and distance in a case where there is an object having a predetermined size or larger or in a case where an object has a plurality of adjacent shapes.

(3). A mobile body control apparatus, in which a three-dimensional map creation unit according to (1) has a distance information generation unit and an attribute information generation unit, and the attribute information generation unit estimates, for an image-capturing target, one or more attributes of a pedestrian, a vehicle, a wall, a tree, a curbstone, a guardrail, and a pole.

(4). A mobile body control apparatus, in which a three-dimensional map creation unit according to (1) has a distance information generation unit and a material information generation and the attribute information generation unit estimates, for an image-capturing target, one or more attributes of metal, stone, tree, and plastic.

(5). A mobile body control apparatus including an image-capturing device that detects an object in an outside world, and a millimeter wave radar device, the apparatus including: a three-dimensional map generation unit that generates a three-dimensional map around a mobile body from information of the image-capturing device; a radar weight estimation unit that estimates, from a three-dimensional shape, a weight of a detection result by the millimeter wave radar device for each region based on a distance and an azimuth using the three-dimensional map; a weight adjustment unit that adjusts reliability of the object detected by the radar device based on a weight estimated by the radar weight estimation unit; and a sensor fusion unit that synthesizes a detection results of an image-capturing device and a millimeter wave radar based on a result of the weight adjustment unit, and outputs a detection result that is synthesized.

(6). A mobile body control apparatus including an image-capturing device that detects an object in an outside world, and a millimeter wave radar device, the apparatus including: a three-dimensional map generation unit that generates a three-dimensional map around a mobile body from information of the image-capturing device; a radar weight estimation unit that estimates, from a three-dimensional shape, a weight of a detection result by the millimeter wave radar device for each region based on a distance and an azimuth using the three-dimensional map; a weight adjustment unit that adjusts reliability of the object detected by the radar device based on a weight estimated by the radar weight estimation unit; and a map prediction unit that predicts and reflects, in a three-dimensional map generation unit of a next frame, a three-dimensional map in a next frame from information of the three-dimensional map.

(7). A mobile body control apparatus including an image-capturing device that detects an object in an outside world, and a millimeter wave radar device, the apparatus including: a three-dimensional map generation unit that generates a three-dimensional map around a mobile body from information of the image-capturing device; a radar weight estimation unit that estimates, from a three-dimensional shape, a weight of a detection result by the millimeter wave radar device for each region based on a distance and an azimuth using the three-dimensional map; a weight adjustment unit that adjusts reliability of the object detected by the radar device based on a weight estimated by the radar weight estimation unit; a sensor fusion unit that synthesizes detection results of an image-capturing device and a millimeter wave radar based on a result of the weight adjustment unit, and outputs a detection result that is synthesized; a composite map creation unit that creates a map from a composite result; and a map prediction unit that predicts and reflects, in a three-dimensional map generation unit of a next frame, a three-dimensional map in a next frame from information of the composite map creation unit.

According to (1) to (7), even when an object not registered on a navigation map induces a detection error of a millimeter wave radar, it is possible to reduce the error and provide a highly reliable sensor system.

### REFERENCE SIGNS LIST

101 image-capturing device
102 millimeter wave radar device
103 vehicle
104 object
105 mobile body control unit
109 control unit
201 object detection unit
202 object detection unit
203 three-dimensional map generation unit
204 radar weight map estimation unit
205 weight adjustment unit
206 sensor fusion unit
207 control unit
301 distance image generation unit
302 object attribute estimation unit
401 specific shape database
402 specific shape detection unit
403 object size measurement unit
404 weight setting unit
601 own vehicle
602, 603 preceding vehicle
604 large trailer
701 map prediction unit
801 composite map creation unit
802 map prediction unit

1. An apparatus for controlling a mobile body that has an image-capturing device and a radar device, the apparatus comprising:
a three-dimensional map generation unit that generates a three-dimensional map around the mobile body from an image captured by the image-capturing device;
a weight estimation unit that estimates, from a three-dimensional shape of each region of the three-dimensional map, a weight of a detection result by the radar device for each region of the three-dimensional map; and
an adjustment unit that adjusts a detection result by the radar device based on the weight.

2. The apparatus for controlling a mobile body according to claim 1, wherein
in a case where there is a first object having a predetermined size or larger in the three-dimensional map,
the weight estimation unit lowers a weight of a detection result by the radar device for each region of the three-dimensional map around the first object.

3. The apparatus for controlling a mobile body according to claim 2, wherein
in a case where there is a second object close to the first object in the three-dimensional map,
the weight estimation unit lowers a weight of a detection result by the radar device for each region of the three-dimensional map around the first object and the second object.

4. The apparatus for controlling a mobile body according to claim 1, wherein
the three-dimensional map generation unit includes
an attribute estimation unit that estimates an attribute of an object detected from an image captured by the image-capturing device,
an attribute of the object to be estimated is
a pedestrian, a vehicle, a wall, a tree, a curbstone, a guardrail, or a pole, and
the weight estimation unit estimates
a weight of a detection result by the radar device for each region of the three-dimensional map from a combination of a three-dimensional shape for each region of the three-dimensional map and an attribute of the object.

5. The apparatus for controlling a mobile body according to claim 1, wherein
the three-dimensional map generation unit includes
an attribute estimation unit that estimates a material of an object detected from an image captured by the image-capturing device,
a material of the object to be estimated is
metal, stone, tree, or plastic, and
the weight estimation unit estimates
a weight of a detection result by the radar device for each region of the three-dimensional map from a combination of a three-dimensional shape for each region of the three-dimensional map and a material of the object.

6. The apparatus for controlling a mobile body according to claim 1, further comprising a sensor fusion unit that synthesizes a detection result by an image-capturing device and a detection result by the radar device adjusted based on the weight, and outputs a detection result that is synthesized.

7. The apparatus for controlling a mobile body according to claim 1, further comprising a map prediction unit that predicts a three-dimensional map in a next frame from the three-dimensional map, wherein
the three-dimensional map generation unit generates
a three-dimensional map around the mobile body from a three-dimensional map of a next frame predicted by the map prediction unit and an image captured by the image-capturing device.

8. The apparatus for controlling a mobile body according to claim 6, further comprising:
a composite map creation unit that creates a three-dimensional map from the detection result synthesized by the sensor fusion unit; and
a map prediction unit that predicts a three-dimensional map in a next frame from a three-dimensional map created by the composite map creation unit, wherein
the three-dimensional map generation unit generates
a three-dimensional map around the mobile body from a three-dimensional map of a next frame having been predicted and an image captured by the image-capturing device.

9. The apparatus for controlling a mobile body according to claim 1, wherein
when the three-dimensional shape is a corner shape or a circle shape,
the weight estimation unit lowers a weight of a detection result by the radar device in a region of the three-dimensional map corresponding to the three-dimensional shape.

10. A method for causing a control apparatus to execute
a three-dimensional map generation process of generating a three-dimensional map around a mobile body from an image captured by an image-capturing device,
a weight estimation process of estimating a weight of a detection result by a radar device for each region of the three-dimensional map from a three-dimensional shape for each region of the three-dimensional map, and
an adjustment process of adjusting a detection result by the radar device based on the weight.
